(19) United States
(12) Patent Application Publication
(10) Pub. No.: US 2004/0022691 A1
(43) Pub. Date: Feb. 5, 2004

(54) Method of manufacturing and design of microreactors, including microanalytical and separation devices

(76) Inventors: Susan D. Allen, Tallahassee, FL (US); Teng Ma, (US); Pat Davis, Tallahassee, FL (US); Joseph B. Schlenoff, Tallahassee, FL (US)

Correspondence Address: Gregory A. Nelson, Esq., Akerman, Senterfitt & Eidson, P.A., 222 Lakeview Avenue, Suite 400, P.O. Box 3188, West Palm Beach, FL, 33402-3188, US

(21) Appl. No.: 10/222,598

(22) Filed: Aug. 15, 2002

Related U.S. Application Data
(60) Provisional application No. 60/312,678, filed on Aug. 15, 2001.

(51) Int. Cl. B01L 3/00

(52) U.S. Cl. 422/102; 422/130; 435/288.4; 436/180

(57) ABSTRACT

A microreactor includes a substrate having a porous bulk and at least one well formed in the substrate. The device can include a plurality of wells, where at least two of the plurality of wells have different structural properties, such as area of the well, depth of the well and porosity of the well. One or more portions of the well surface can be functionalized to produce desired properties, such as porosity. A method for forming microreactor devices includes the step of providing a substrate material having a porous open cell substrate core portion and removing discrete portions of the substrate to form at least one well in the substrate material. The removing step can include the process of laser ablation. A whole cell sensing device includes a substrate having a porous bulk, at least one well formed in the substrate, and at least one whole cell disposed in the well.

### CROSS-REFERENCE TO RELATED APPLICATIONS

This application claims the benefit of U.S. Provisional Application No. 60/312,678 entitled METHOD OF MANUFACTURING AND DESIGN OF MICROANALYTICAL DEVICES filed Aug. 15, 2001, the entirety of which is incorporated herein by reference.

### STATEMENT REGARDING FEDERALLY SPONSORED RESEARCH

Not applicable.

### FIELD OF THE INVENTION

This invention relates generally to microreactor devices. More particularly, it relates to microreactor devices formed from substrates having a porous bulk.

### BACKGROUND OF THE INVENTION

There is currently interest in developing nano and microscale analytical systems, separation and other reactor systems and related devices for a wide range of applications. For example, such analytical systems have been considered for the measurement of blood glucose levels, HIV, carcinogens, pathogens and other environmental contaminants as well as measuring the presence or absence of chemical and biological warfare agents. These systems operate by collecting and distributing a sample containing an analyte for testing, exposing the sample to one or more reagents and detecting the presence or absence of the analyte.

Work is also in progress to develop specific reactions with high sensitivity and specificity for various biologically and environmentally active components. There is also a growing body of work in microfluidics, in both gas and liquid phase, for collecting and processing samples to be tested, such as a body fluid, air or water. Detection schemes include separation processes such as capillary electrophoresis or capillary electrochromatography with electrochemical or spectroscopic readout and antibody-antigen reactions that activate fluorescent tags.

Micro and nanoscale analytical devices are desirable as they use very little sample and can be manufactured economically. Most of the devices currently being developed use microchannels or capillaries. Both microchannels or capillaries have a number of common shortcomings. First, these devices do not provide sufficiently high surface area to volume ratios. In addition, these devices have minimum dimensions of about 10-100 μm or more for proper operation. Moreover, microchannels or capillaries are generally used as separators, not as reactors. It would be desirable to provide an analytical device having the capability of being scalable from nanosize to millimeter size, formed from inexpensive materials, and capable of being used as both separators and reactors, such as nano or micro reactors.

### SUMMARY OF THE INVENTION

A method for forming microreactor devices includes the steps of providing a substrate having a porous bulk and removing discrete portions of the substrate to form at least one well in the substrate material. The well can provide access to the porous bulk. The substrate can be selected from polymers such as polystyrene, polyethylene, polypropylene, polyurethane or other porous materials such as metal foams, porous ceramics and aerogels and hydrogels.

The substrate can provide a non-porous surface layer. In this embodiment, the removing parameters used for the removing step can be selected to remove the non-porous surface layer without substantially fusing portions of the underlying bulk substrate portion exposed by the removing step.

The method can include the step of placing a surface modification agent into at least one of the wells. The surface modification agent can be a surfactant, such as sodium dodecyl sulfate (SDS) or sodium laureth sulfate (SLES). The surface modification agent can change the chemical binding characteristics of at least a portion of the porous bulk.

The removing step can comprise laser ablation. The removal process is preferably computer controlled and can provide controlled translating of the substrate relative to a removal source.

The method can include the step of applying an index matching fluid to the substrate prior to the removing step. The index matching fluid permits foam/index matching so that the substrate becomes substantially transparent (e.g. minimal scattering) to the laser to a desired depth below the surface of the foam. The laser is then focused at a depth below the surface of the foam. As a result of the high energy density near the focus point below the surface of the substrate as compared to the surface of the substrate, an ablating or melting region results near the focus point of the laser energy without ablating or melting the surface of the substrate to form the sub-surface well or channel portion. Following irradiation, the index matching fluid is generally removed, leaving a buried well or channel with either fused or porous structure.

A microreactor device includes a substrate material having a porous bulk, and at least one well formed in the substrate. The device can be a multi-well device, where the wells can have different structural or geometric properties. Well walls can be locally or globally porous or nonporous, and can be made hydrophilic, hydrophobic or with tailored attraction or repulsion of specific chemical species. Wells can include a surface modification agent which can change the chemical binding characteristics of at least a portion of the porous bulk. Wells can also be configured as buried channel or chambers, or surface channels or chambers with a bonded cover sheet, and can thus be used for microfluidic applications. Electrically conductive electrodes can be disposed in the wells or channels to propel fluid through the porous substrate.

A whole cell sensing device includes a substrate material having a porous bulk, at least one well formed in the substrate, and at least one whole cell disposed in the well. The device preferably includes a non-porous and substantially rigid support, wherein the substrate is disposed on the rigid support. The device can include an optically transparent cover plate disposed on the substrate.

A method for transporting fluids includes the steps of providing a substrate material having a porous bulk, and flowing at least one fluid through at least a portion of the porous bulk. At least one well or channel can be formed in the substrate. The flowing step can be under the influence of an electrical field.

An artificial organ or functional tissue comprises a substrate having a porous bulk and at least one functionalized surface formed from the porous bulk. Cellular material disposed in or on the functionalized surface. Structure is provided for supplying nutrients to and removing metabolic products from the cellular material.

### BRIEF DESCRIPTION OF THE DRAWINGS

A fuller understanding of the present invention and the features and benefits thereof will be accomplished upon review of the following detailed description together with the accompanying drawings, in which:

FIG. 1(a) illustrates a one (1) well device according to an embodiment of the invention.

FIG. 1(b) illustrates a reactor device formed from a thin porous foam sheet mounted on a non-porous and preferably transparent support layer, according to an embodiment of the invention.

FIG. 2 illustrates a two (2) well device according to an embodiment of the invention.

FIG. 3 illustrates a three (3) well device, according to another embodiment of the invention.

FIG. 4 illustrates a separation device including a plurality of foam strips.

FIG. 5(a) illustrates a side view of an exemplary whole cell sensor device fabricated in an open cell foam, while FIG. 5(b) shows a top view of the same.

FIG. 6 illustrates another whole cell sensor device fabricated in an open cell foam.

FIG. 7 illustrates a surface adherent cell sensor device fabricated in open cell foam.

FIG. 8 illustrates a gas sensor fabricated in open cell foam.

FIG. 9 is a diagram of a laser system for forming wells, according to an embodiment of the invention.

FIG. 10 is a table listing laser setup parameters and resulting well depths.

FIG. 11(a) is a plot of hole depth as a function of shot quantity.

FIG. 11(b) is a plot of depth/(energy density) as a function of shot quantity.

FIGS. 12(a) and (b) are plots of hole depth as a function of shot quantity.

FIG. 13 is a plot of hole depth vs. shot quantity.

FIG. 14 is a plot of depth/shot vs. shot quantity.

FIG. 15 is a plot of depth/shot vs. shot quantity.

FIG. 16 is a plot of depth/shot vs. shot quantity.

### DETAILED DESCRIPTION OF THE INVENTION

An microreactor device includes a substrate having a porous open cell bulk and at least one well formed in the substrate. The microreactor can be a microanalytical or separation device, including a mixer and a sensor. The devices can be nanometer or larger size, formed from inexpensive materials and be created having customized permeabilities to specific materials depending on the intended application. Devices can include a plurality of wells, where at least two of the plurality of wells have different structural properties, such as area of the well, depth of the well, shape of the well and porosity of the well. Individual wells can include both non-porous and porous portions.

Devices can include any number of wells, the wells having any suitable area and depth. Wells can be square, round, rectangular or an irregular shape. When multiple wells are used, wells can have different sizes and have different porosities. When at least three wells are used, the spacing between respective wells may also be varied.

When non-porous walls are provided, materials placed in wells can diffuse through the well walls into the porous substrate. The rate of diffusion can be controlled by the concentration of the material, the well size, the wettability (surface potential) and/or the chemical binding/attraction of the treated porous surface, the porosity of the well walls and the porosity of the substrate material. Walls of wells can have a porosity different from the porous substrate. The porosity of individual well walls can be non-uniform and provide for directional (as opposed to isotropic) flow of materials, such as analytes.

Surface treatments can be used to modify the well surface characteristics and cause the diffusion rate of materials placed in wells to either increase or decrease. Surface treatments can include various coatings. For example, a hydrophobic surface layer may be modified to become hydrophilic when aqueous solutions are used. Different coatings can be used in different wells on the same device, such as the coatings disclosed in U.S. Pat. No. 6,409,900 to Parce et al. entitled “Controlled fluid transport in microfabricated polymeric substrates”.

A method for forming devices includes the steps of providing a substrate having a porous bulk and removing discrete portions of the substrate to form at least one access port, such as a recessed well region in the substrate. The removing parameters can be controlled, preferably through computer control, to produce a predetermined well area, well depth and well porosity.

Specifically, removing parameters can be provided which can remove substrate material, without substantially fusing the open cell core. Thus, well walls can be formed having significant porosity and resulting in permeability to a variety of substances. Thus, the invention provides ready access to a high surface area porous material having easily modifiable surface properties.

A porous material is solid material with open spaces within it. The open spaces are called pores. Thus, materials which have pockets of space in their bulk are therefore said to be porous. For example, open-cell or porous foam of several polymers, including polystyrene, polyethylene, polypropylene and polyurethane, can be obtained commercially with a range of pore sizes from microns to several hundred microns. If pores are not fluidly connected, the material is considered a closed cell material. However, if the pores are fluidly connected, the material is referred to as being an open pore material and is effectively one multiply connected “pore.”

The volume fraction of pores is commonly called the porosity, and is denoted Φ=Vp/V, where Vp is the volume of the pore phase (the holes) and V is the total volume of the material. The solid volume fraction is then 1−Φ, which is equal to the relative density of the foam.

A common approach in defining the micro-geometry of porous materials is to consider them to be two-phase solid-pore composites, even though the solid phase can be heterogeneous. Properties such as diffusivity and permeability are functions of pore size, shape, and connectivity, and generally increase as the porosity increases. However, materials of the same porosity may exhibit different diffusivities as the pore sizes of the respective materials can be different. Smaller pore sizes yield lower diffusivities and vice versa, while the relative surface area is larger for smaller pore sizes.

The topology of the pore space of a porous material is very important in determining the properties of the material. Pore topology relates to how the pores are connected, if at all. If the pores are completely isolated from each other by solid material, the shape and size of individual pores can be defined. Thus, a pore size distribution can be defined, a quantity which gives the number or volume of pores of a given size. In most cases, porous materials are random materials, with random pore sizes, shapes, and topology. Because of this fact, most porous materials tend to be isotropic. This is not always the case, however.

In open cell materials the idea of “throats” can be important. Throats are relatively small cross sectional area conduits which connect adjacent “pores.” In certain cases, the idea of a throat shape and size may be loosely defined. The size of the “throat” can limit the accessibility of the larger “pore,” and can be the size of importance for many properties of the open materials.

In certain embodiments of the invention, unlike conventional microfluidic and other flow devices, fluids are flowed through at least a portion of the porous bulk substrate. Accordingly, high porosity and corresponding low relative density foams are generally preferred for these applications. Polymer foams generally have a range of relative density of from about 0.002-0.2, with 0.05 (5%) being typical. Typical open cell polystyrene foams have pore sizes of 60 μm diameter with a cell wall thickness of 0.7 μm and cell windows or throats of 30 μm. Microporous or microcellular foams have pore sizes of generally less than 10 μm and approximately 10⁶ pores/cm³. The substrate relative density can be less than 5%, less than 2%, less than 1%, or less than about 0.1%.

The invention includes a method of using open cell porous materials, such as polymer foams, to make inexpensive, readily disposable analytical, separation and other reaction devices. Devices can be nano, micro or millimeter size devices for microanalysis up to meters in size for larger scale bioreactors. Porous materials can include polymers such as polystyrene, polyethylene, polypropylene, polyurethane or other porous materials such as metal foams, porous ceramics and aerogels and hydrogels and nanotube arrays or composites. In a preferred embodiment of the invention, polystyrene is used.

Polystyrene is readily produced in a foam form, and exists in both closed and open-cell forms. Open-cell polystyrene consists of a porous bulk, enabling it to have many absorptive qualities. This open-celled bulk, however, is covered by an impermeable surface layer of fused cells. The fused non-porous surface layer results from the production process of the foam, when the foam is extruded between a series of hot rollers. This sheet-forming process melts and fuses the surface cells of the polystyrene. Portions of the fused surface region can be removed to exploit the absorptive capability of the polystyrene foam.

A suitable removing step, such as laser ablation, high pressure water jets, focused ultrasonic, bead blasting, reactive ion etching (RIE), wet or gas phase chemical etching, mechanical cutting or various sputter techniques can be used to remove substrate material to form desired structures. In the case of polystyrene, the fused nonporous layer can be removed from discrete portions of the material to make structures in the polystyrene that allow access to the porous open cell interior. Lithography techniques, such as those analogous to those used in the microelectronics industry, may also be used whereby a pattern is formed by exposing discrete portions of the substrate to processing while protecting other regions with a protective, and later optionally removable, masking layer. Current lithography permits feature sizes to be printed to be as small as approximately 75 nm. The challenge is to remove the surface layer without damaging the porous underlying structure. In the preferred embodiment of the invention, a laser is used for removing substrate material.

A laser permits use of the process of laser ablation. Laser ablation is a preferred method for material removal due to controllability of ablation depth and surface temperature. Laser ablation can be computer controlled, where a desired patterned in a substrate is produced automatically by translating the substrate or the laser during the ablation process. The mechanism of laser ablation of polymers is not currently fully understood. The most recognized model to date involves the laser pulse, consisting of photons, being absorbed by the material. The photons excite the radiated material to an upper energy level, which may decay to thermal energy, resulting in the material breaking into polymer fragments in a combined photochemical/thermal decomposition reaction.

Laser ablation can be used to form subsurface (or buried) channels in the porous substrate material, where the surface of the substrate can remain substantially intact. This can provide another dimension of flexibility and the ability to make monolithic devices with microfluidics.

One method of forming buried channels utilizes a refractive index matching fluid. An index matching fluid can be applied to the porous substrate material to fill the pores in a given substrate volume prior to ablating. The index matching fluid is preferably chosen to avoid, or at least substantially reduce, electromagnetic scattering of the incident radiation at the air/polymer boundaries in the open cell substrate material.

For example, bulk polystyrene has a relatively high refractive index (n_{fx}) of about 1.6. Polystyrene foam has a refractive index slightly less than the corresponding bulk material. Suitable index matching fluids for polystyrene include an oil from Cargille Laboratories, Inc., Cedar Grove, N.J. Catalog #20270; laser liquid code 5763; nf at 589.3 nm=1.580, n_{f} being higher at shorter wavelengths. The index matching oil can be diluted preferably with a low viscosity solvent to reduce the viscosity and to adjust the refractive index.

The laser intensity selected should be chosen to be sufficient to create breakdown and/or damage to the porous substrate at the focus location. The laser wavelength should be chosen such that the polymer foam/index matching fluid is reasonably transparent. The laser can then be focused at a desired depth below the substrate surface.

Following the desired removal process at the focused location, the sample and/or the laser beam can then be translated to create a subsurface channel. After micromachining, the index matching fluid can be drained from the porous substrate material leaving the completed micromachined structure including subsurface channels or chambers. Through routine experimentation, the chemistry of the index matching fluid and the laser intensity can be optimized for a given substrate material to form either sealed or open pore channels or chambers.

In most embodiments of the invention, it is desired to form wells having at least a portion of their walls being porous, and thus fluidly connected to the open cell substrate core. Accordingly, applied to polystyrene, removing the fused layer without substantially damaging the porous open cell structure exposed by the removing step requires careful choice of the parameters used to form the structures. The laser removal process can be controlled by controlling laser parameters such as laser wavelength, pulse length, intensity, repetition rates, aperture sizes, and demagnification factors.

Excessive heat is believed to cause melting of the open celled polystyrene core and fusing the cells together. Thus, it is generally desirable to perform the removal step using high laser energy densities so that significant material can be removed in one laser pulse, without recreating the fused surface. It may also be possible to include a cooling apparatus, and/or perform the ablation process at a temperature below room temperature.

The invention applied to polystyrene can be used to provide access ports to the porous bulk by cutting conduits in the non-porous layer on the surface of the bulk polymer. Polystyrene foam absorbs wavelengths in the ultraviolet (UV) and infrared (IR) spectrum very readily. For this reason, excimer and CO₂ lasers have preferably been used. Laser micromachined access wells in the polystyrene foam have been successfully demonstrated using both excimer (248 nm) and CO₂ lasers (10.6 μm). Other wavelengths will likely be suitable for the invention, the suitability depending on the specific substrate material. By appropriate choice of the laser parameters, such as power, either a fused or porous surface or a combination thereof can be produced in the laser micromachined wells or channels.

Certain potentially useful porous substrates are hydrophobic. For example, polystyrene is hydrophobic and must be made wettable by water-based samples in order to be useful for many applications. Molecules having a non-polar tail and polar end group will generally polarize nonpolar porous substrate surfaces via binding of the non-polar tail of the molecule to the non-polar surface. For example, polystyrene can be treated with a surfactant, such as sodium laureth sulfate (SLES) or sodium dodecyl sulfate (SDS), which can make the surface of the polystyrene foam polar and therefore wettable. Polarization of the substrate surface can also allow the attachment of other surface modification materials such as polyelectrolytes containing the appropriate reactive site for sensing applications. Additional surface treatment methods which can be used with the invention are disclosed in U.S. Pat. No. 6,409,900 to Parce et al.

The process used to render the non-polar substrate, such as polystyrene, hydrophilic, depends on the application. Open-celled polystyrene may be used in layers of a few millimeters as filters. In this case, the surface foam may be sulfonated to create hydrophilicity. If the solution being absorbed is water-based, a surfactant may be added to allow the solution to “wet” the surface. Another application of open-celled polystyrene is to function as a column in capillary electrophoresis and other separation process. Inexpensive and efficient capillary electrophoresis, electrochromatography, conventional chromatography and related devices can be formed using the invention. When necessary, electrically conductive electrodes can be disposed in the wells or channels formed. The invention can support these devices by permitting component separation from a mixture of components by diffusing the mixture through the high surface area porous bulk substrate. The porous bulk can be treated to produce either noninteracting surfaces as in capillary electrophoresis or specific interactions as in electrochromatography, gel electrophoresis or conventional liquid phase chromatography.

Wetting tests were performed with hydrophobic polystyrene. Ultrasonic and simple dipping were performed at two different concentrations of SLES, 10 mM and 100 mM. Then the samples were rinsed and dried. Both produced wettable surfaces. In one case, several different dyes of different polarities were used to test the wettability. All tests were successful.

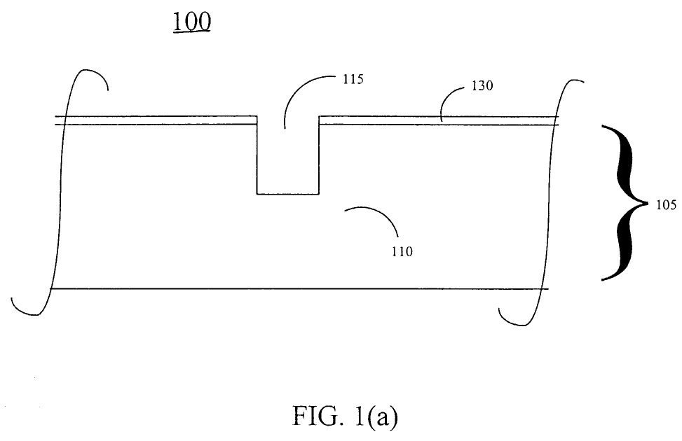

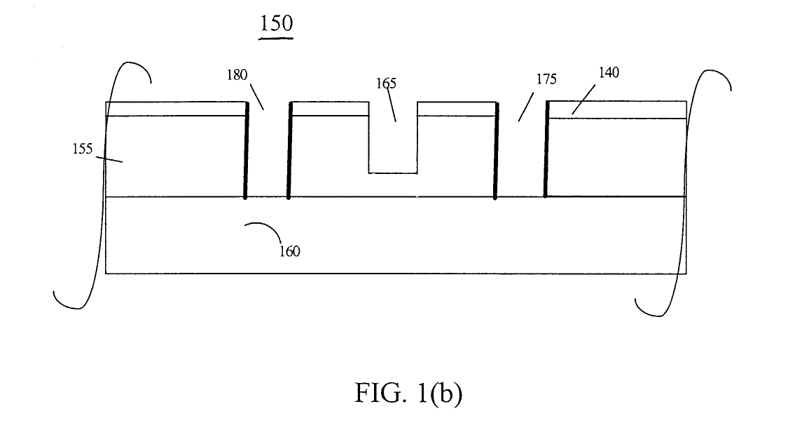

As shown in FIG. 1(a), one embodiment of the disclosed invention is a one well device 100 having single well 115 formed in a substrate 105. The substrate 105 comprises a porous bulk open cell foam 110 covered by a fused non-porous surface layer 130. Device 100 can operate by impregnating the surface of well 115 with reactant. An analyte sample can then be placed in well 115.

The removal step used to form well 115 can be based on any energetic beam or other removal mechanism capable of removing substrate material without significantly affecting surrounding substrate regions or the underlying open cell structure. For example, laser sources have been used successfully for this purpose. If a porous substrate material has a non-porous surface layer as in the case of polystyrene, a laser or other energetic source can be used to penetrate the surface nonporous layer to uncover the porous substrate.

It is generally preferred to set removing parameters to produce wells having exposed open core portions. In the case of polystyrene, removal parameters preferably remove the nonporous surface layer but do not substantially fuse at least a portion of the open cell core regions exposed by the removing step. In some applications, it may be desirable to avoid substantially fusing the entire open cell core region exposed by the removing step in one or more wells.

By appropriate choice of laser irradiation conditions, the sides and bottom of the laser formed well can selectively be imparted differing porosities. For example, the substrate 105 can be tilted relative to the laser or other beam to direct removal or pore/cell fusion to a particular wall. Making one or more sidewalls non-porous by cell fusion can be used to direct reactants, for example, in a particular direction. Sealing the well bottom and three (3) of the four (4) sides of the well can focus diffusion of reagent (or reagent residue or sample) substantially in a single direction. For example, in a three well device where the sample is placed between two reagent ports, there is no advantage to impregnating the reagent well volume on the wall away from the sample port, so it may be desirable to seal the bottom and side walls away from the central sample port. In addition, this device geometry provides limited mixing of the two reagents prior to sample introduction.

In some cases it may be desirable to increase the density of multi-well devices and/or to decrease the amount of reactant used. For example, FIG. 1(b) shows a reactor device 150 formed from a thin porous foam sheet 155 mounted on a non-porous and preferably transparent support layer 160. A non-porous surface layer 140 covers foam sheet 155. Reaction well 165 having porous walls is formed in foam sheet 155. The depth of reaction well 165 can be varied, and may or may not reach support layer 160. The thin porous foam sheet 155 is micromachined all the way through the porous foam to reach support layer 160 to form nonporous-walled wells 175 and 180. Thus, porous walled reaction well 165 is disposed between nonporous-walled wells 175 and 180. The fused “moat” structure formed preferably completely surrounds the porous-walled well 165. This type of device 150, which can be extended to multi-well devices, allows denser packing of the wells and reduce the amount of reactants needed as diffusion out of the reaction zone is limited by the “moat.” The transparent support can allow optical detection, if desired.

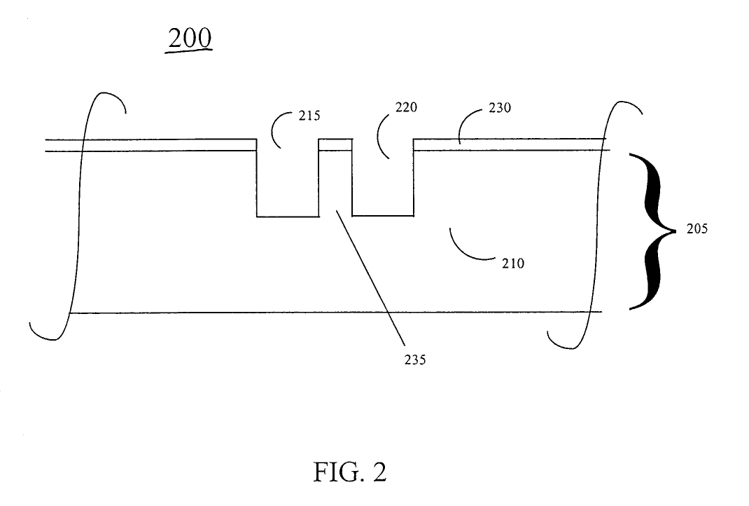

As shown in FIG. 2, another embodiment of the disclosed invention is a two port device 200 formed in a substrate 205, the substrate 205 comprising open cell foam 210 covered by a fused non-porous surface layer 230. Wells 215 and 220 can be formed with different areas, different depths and different porosities to produce desired properties, such as porosity. As noted relative to the single well embodiment, sealing the well bottom and/or one or more sides can be used to focus the diffusion of reagent (or reagent residue) out from respective wells.

To continue this description, it will now be assumed that the removing step uncovers substrate surfaces which are porous to form two wells 215 and 220 in the porous substrate 210. In the case of polystyrene, this would correspond to the removing step resulting in access to the open cell structure of the polystyrene foam.

One or both wells 215 and 220 can be first treated with a wetting agent such as SDS or SLES as described above. Additional surface modification agents may be applied. One or both wells 215 and 220 can then be treated with a sensing agent and the structure can be allowed to dry to leave a residue of the sensing agent. In this system, the sample to be analyzed, e.g., water, spit, blood, urine, etc., can be placed into one of the wells such as 215 and reacts with the sensing agent which diffuses from its well 220 to contact the analyte of interest in an open pore region 235 between the respective wells. The readout may be based on color change, fluorescent detection or other common detection methodologies. The second well may be used for a standard to compare with the sample. The readout equipment can be conveniently housed in a separate instrument.

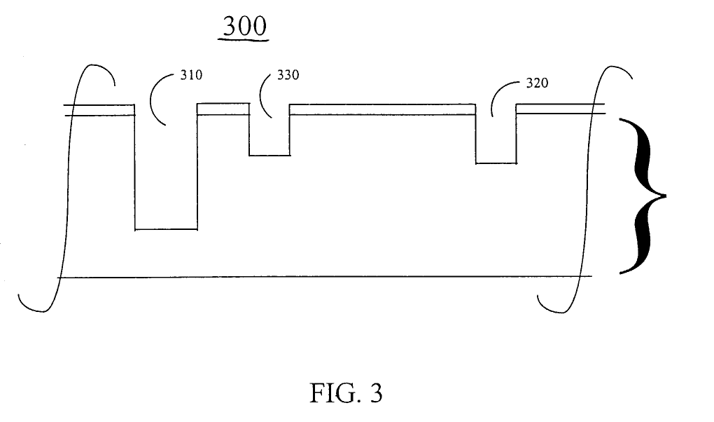

For some applications, more than two wells may be desired. For example, a three well device 300 shown in FIG. 3 permits two reagents to be deposited in respective reagent wells 310 and 320. As shown in FIG. 3, reagent wells 310 and 320 have different sizes and different spacings from central well 330. Size and spacing can be tailored to produce a variety of desired characteristics, including diffusivity. The sample to be tested can be dropped into the central well 330, mixed with the two reagents and produce the appropriate sensing change. Although only two reagent wells 310 and 320 are shown in FIG. 3, device 300 can include many more reagent wells. It may also be possible to form devices having a plurality of sample wells.

The invention can be used to form surface microfluidic channels that can be sealed with a bonded cover layer. For example, U.S. Pat. No. 6,132,580 to Mathies, et al. discloses several microfluidic structures having sealed cover layers which can be adapted for use with the invention. Surface channels can be formed by conventional methods and then wells or porous areas can be opened up as desired. Alternatively, microfluidic channels can be formed with hot wire or laser fusion of the porous foam, again with a bonded top. It is known that rough surfaces can enhance fluid flow in microchannels. Laser fused surfaces have been found to generally produce relatively rough textured surfaces.

Structures formed using the invention can also be used for performing separations. Several different separation schemes commonly used in biochemistry and molecular biology for both analytical and preparative purposes can be formed using the invention. For example, protein mixtures can be separated using gel electrophoresis to determine the molecular weight distribution of the protein mixture. This information can be used for the identification of the products of protein synthesis reactions. The readout may be spectroscopic, fluorescent or by dye staining.

Capillary electrophoresis (CE) can also be used to separate molecules. In CE, electric field induced flow in small diameter capillaries (10-100 μm) is used to separate molecules. Both CE and standard electrophoresis are one phase techniques in that interaction with a wall or surface does not contribute to the separation process. In gel electrophoresis, size “sieving” occurs in flow through the small pores of the gel. In chromatography, the interaction of the analyte and the surface of the medium (beads, powders, etc.) provides discrimination between and resulting separation of molecules.

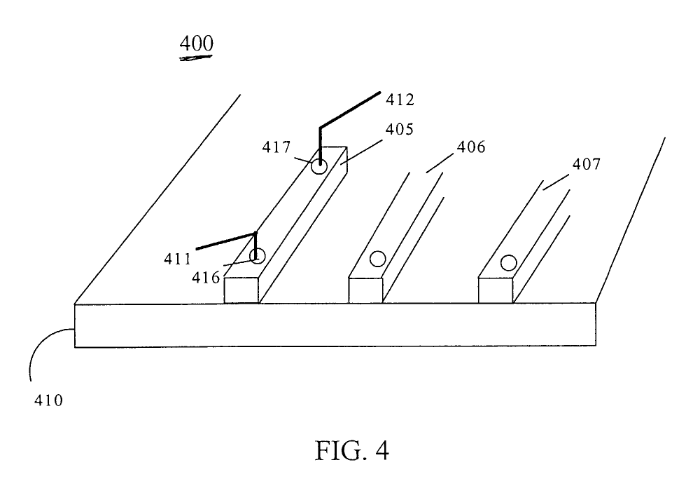

Simple, inexpensive devices can be manufactured in porous substrates such as porous polymer foams using the invention, to produce electrophoresis or chromatographic devices. Channels can be micromachined using any of the methods discussed or known in the art. Separation device 400 shown in FIG. 4 includes thin foam strips 405, 406 and 407 formed from a thin polymer foam sheet. Foam strips 405-407 have fused or porous side walls and porous access ports at each end of the channel. Foam strip 405 is shown having access wells 416 and 417, a pair of electrodes and associated contacts 411 and 412 in the respective wells 416 and 417. Electrodes 411 and 412 disposed in the wells at the end of strip 405 provide the driving field for the electrophoresis, electrochromatography or electroosmosis separation. Strips 406 and 407 can include electrodes (not shown). Thin foam strips 405-407 can be permanently attached to a solid support layer 410, if desired, or clipped to a solid base containing the electrode structure. The porous foam is generally treated with appropriate reagents to provide wettability and separation capability. The sample to be analyzed or separated is added to one of the wells and an appropriate electric field applied.

Gels could also be formed in the porous foams, providing an inexpensive, disposable gel electrophoresis medium. For this application, relatively large pore, low density foams would be preferred.

The foam strips can be made with either porous or nonporous sides, depending on whether access is required to the media after electroseparation. For fluorescent or spectroscopic detection, sealed sides can be made by hot wire, stamping, laser or other means of cutting to produced sealed surfaces. As the foam strips are thin and filled with an aqueous solution, it is possible to view fluorescence or probe optically through the liquid-filled foam. If dye staining is used, the sides of the strips should be at least partially porous to allow the dye to penetrate the structure after separation. Porous sides can be created by conventional means such as sawing, bead blasting, laser micromachining or other suitable methods.

One of the problems with CE is the restriction to small sample size. This limits the sensitivity and precludes preparative CE separation of large amounts of a particular molecule. Capillary arrays are not generally a practical extension of the CE technology as the capillaries are not sufficiently reproducible to allow homogeneous flow through an array. Tubes or bars of porous foams with surfaces appropriately functionalized to not interact with the analyte could serve as the equivalent of a capillary array. While this material is not microscopically homogeneous, it is homogeneous on the average. Such tubes or bars could be extruded in the required shape, providing a porous interior and sealed surface and cut to desired lengths using mechanical or other means to produce porous access ports. Similar structures could be functionalized to serve as liquid chromatography columns.

The invention is also expected to have significant commercial and military applications. Small scale sensors can be formed for use on unmanned autonomous vehicles. Cheap, disposable sensors can be widely distributed on a potential battlefield. Such sensors would contain a power supply and small microwave transmitter to send test results to a larger communication module for upload to a monitoring station.

Moreover, the invention can be used to form efficient (due to the high surface area to volume ratio offered) and potentially small systems with concentrating or separation capability. These systems are expected to be highly useful for widescale monitoring of environmental contaminants and preparative separations.

The invention can also be used to form sensors which are also ideally suited for use in medical applications as the sensors are small, inexpensive and easy to dispose of. A major market would likely be medical diagnostics, either in the physician's office if the readout is complex and/or expensive or home testing if the readout can be made simple. A simple readout could be a color change or even a simple fluorescent device using a blue LED with filters to sense a green or yellow fluorescence, for example. The invention largely solves one of the problems with medical diagnostics, i.e., the disposal of potentially hazardous material. As this device is preferably made of plastic foam, it can be readily and safely incinerated.

Different types of cells generally adhere to different surface geometrical features. Laser micromachining is preferably used to produce varying geometrical features. The ability to pattern three dimensional devices and to effect cell adhesion with or without additional surface treatment could provide a significant simplification of the fabrication process for whole cell sensors. Depending on the substrate, various techniques can be used to make the well surfaces hydrophilic, hydrophobic or with a specific surface potential, as desired. As noted above, surfactants such as SDS can be used to render polystyrene surfaces hydrophilic.

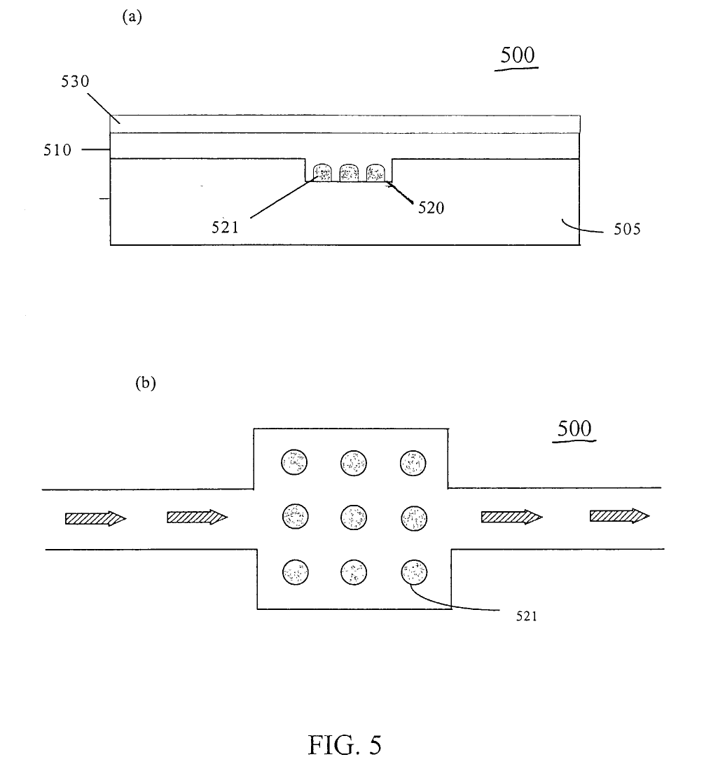

A side view of an exemplary whole cell sensor device 500 is shown in FIG. 5(a) with a top view of the same shown in FIG. 5(b). Sensor device 500 can provide downstream analysis. Only one microfluidic channel 510 and one well 520 formed in porous substrate 505 is shown in FIGS. 5(a) and 5(b) for simplicity only. Well 520 holds a plurality of cells 521. Sensor device 500 can include an optional cover plate 530, which can be selected to be optically transparent if optical signals are to be detected, such as in fluorescence spectroscopy.

The invention can include a plurality of wells and microfluidic channels. The channels can be made locally or globally fluidicly connected to or isolated from the porous bulk, depending on the intended application, by either not fusing the porous substrate walls in the case of desired fluid connection, or fusing the porous substrate walls in the case isolation is desired. Channels can be used to connect various portions of devices as in standard microfluidics.

Thus, the invention can be used to form an array of microfluidic channels connected to several wells with a defined array of cells deposited in the arrays. Cell health, for example, can be monitored either by analysis of metabolic products produced or fluorescence through the transparent cover 530. An important feature provided by sensor device 500 is the adhesion of cells to specific geometric features in the wells. It is well known that surface chemistry and texture influence cell adhesion and growth. Boyan B. D., T. W. Hummert, D. D. Dean and Z. Schwartz, “Role of material surfaces in regulating bone and cartilage cell response”, Biomaterials 17, 137 (1996). For purposes of illustration, FIG. 5(b) shows a 3×3 array of cells 521 in well 520, although more or less cells may be used, depending on the specific sensor.

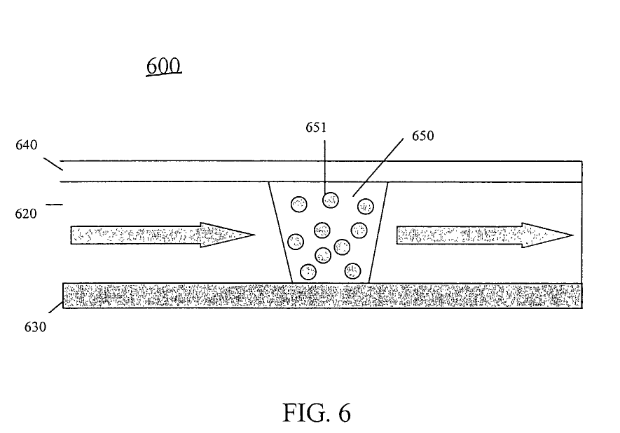

Another sensor device 600 that illustrates certain advantages of porous foam sensors is illustrated in FIG. 6. A thin sheet of a porous substrate 620, such as polystyrene foam, for example, is attached to a non-porous and preferably rigid substrate 630, which may or may not be transparent. Channels or wells 650 can be laser micromachined through the polymer skin, leaving the porous foam structure exposed on the sides of the well. The foam surfaces are then treated to make them hydrophilic and cells 651 and a nutrient solution (not shown) can be added to the well 650. A transparent cover 640 can then be applied to seal the top surface of device 600. Nutrient and growth inhibitors can be renewed by flow through the porous foam “sandwich” as shown by the arrows. Analyte is also introduced in the same manner. In this case, certain cancer or blood cells, for example, can be chosen as the sensor species because they tend to remain in suspension and may not generally adhere to surfaces. The pore size of the foam is chosen to be small enough to prevent the migration of the cells into the foam itself. Readout can be accomplished by interrogation of fluorescent tags through the transparent window or by analysis of cell metabolites in the nutrient stream.

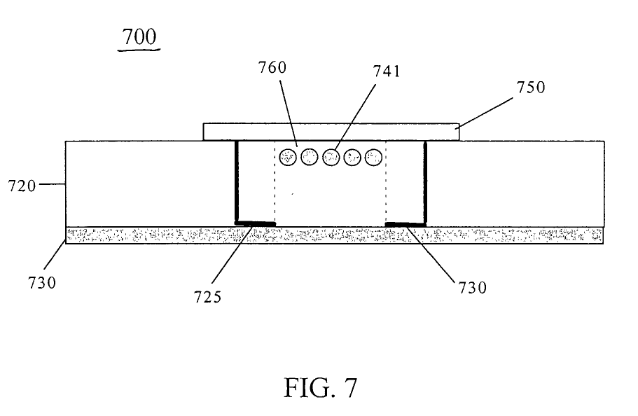

FIG. 7 illustrates a surface adherent cell sensor device 700 fabricated in open cell foam 720. A thin sheet of a porous substrate, such as polystyrene is shown attached to a non-porous and substantially rigid substrate 730. Two parallel channels 725 and 730 are micromachined in the foam layer, preferably using a laser. In this case, the laser conditions are chosen so that the outer walls (bold lines) are sealed while the inner walls (light lines) are left porous. The pore size of the polymer is chosen to be large enough for cells to migrate into the foam. In one embodiment of device 700, the top impermeable layer of the central pillar 760 is removed and the porous foam is treated to be hydrophilic. Nutrient solution is added and the top of the pillar is inoculated with surface adherent cells 741. A transparent cover 750 can then be attached to seal the channel structure. Nutrient is fed into one channel, and measurements are made on the outflow from the other channel after diffusion through the central pillar.

In some cases, it may be advantageous to use larger cell foam and to permeate the central pillar 760 with cells that will adhere to the walls of the pores but not significantly impede flow through the pillar 760. Alternatively, if the central pillar is sufficiently narrow, such as, about 300 microns wide, there will generally be sufficient diffusion through the cell-filled porous structure to support cell viability.

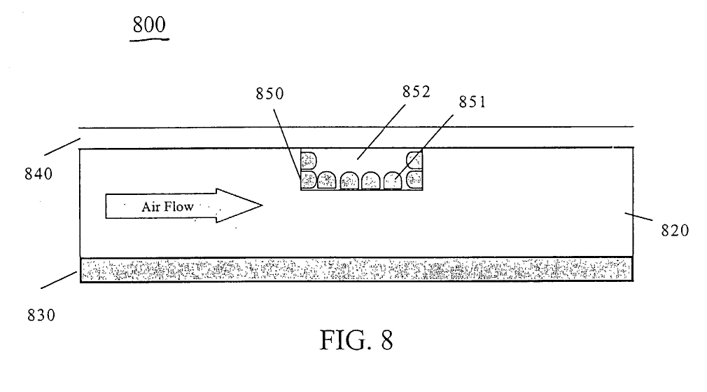

A gas sensor 800 is shown in FIG. 8. In the previous sensing devices shown in FIGS. 5-7, analyte is delivered via a liquid stream. While many toxins/pathogens to be tested are in water or water solution, air testing normally requires collection of a large amount of air and bubbling it through water to create a liquid analyte. FIG. 8 shows a structure for air-borne pathogen/toxins that mimics the operation of the lung. Sensor 800 includes a laser micromachined channel 850 in a thicker layer of porous material 820, leaving all micromachined surfaces porous. Sensor 800 preferably includes non-porous and substantially rigid substrate 830 and cover 840, which is preferably optically transparent. The porous surface is derivatized to make it hydrophilic and cells 851 and nutrients 852 are added to the channel 850. The pore size, in this case, is chosen such that the endothelial cells (or any selected cells) completely fill the pores adjacent to the channel.

A stream of air to be tested for toxicity then replaces the nutrient solution in the rest of the porous structure. The air encounters the epithelium-like structure on the outside of the nutrient filled channel 850 and interacts with it in much the same way air interacts with the epithelium in the alveoli in humans. Readout can be by metabolic products or by fluorescence through the transparent cover 840. In some cases, it may be advantageous to reverse the liquid and gaseous phase structures, using the porous structure to carry the liquid phase and the channel structure for the gas phase. Particularly for this latter embodiment of the device, the channels can be made serpentine and/or multiply parallel to increase the contact surface with the air stream. Other types of gas sensors can be configured using the invention.

The invention may also be used as a porous substrate material to form artificial organs for use in humans and animals or in the large-scale production of biologically active molecules requiring three-dimensional substrates. The terminology “artificial organs” is used herein to denote devices that could be implanted into a human or other body and “functional tissues” to denote devices that are used for the large-scale production of biologically active molecules. For example, new methods of fighting cancers and viral infections have been suggested which could result from recent advances in tissue engineering that have created an “artificial thymus” [NIST Research for Industry entitled “Technology at a Glance”, Winter, 2001, pgs. 1-2]. The engineered thymus gland efficiently generates large quantities of a wide range of human T cells, a key element in the body's immune system.

The conventional method of growing T cells in flat culture dishes for therapeutic purposes is inefficient because geometry plays a critical role in the maturation of T cells. Organs are three dimensional (3D) structures, whereas 2D culture plates cannot efficiently form cells that require 3D support. The invention can provide 3D functionalized substrates analogous to the porous structures found in actual organs. In some cases, biodegradable polymers such as polyethylene glycol (PEG) or polylactic acid (PLA) should be used to make the porous substrates. In other cases, it may be desirable to retain the underlying porous support structure for the artificial organ or functional tissue. Access to the functionalized porous structures can be controlled using the nano or micromachining techniques described herein. Alternatively, large areas of porous structure can be exposed, using conventional techniques such as sawing, to produce slab-like membrane stacks.

### EXAMPLES

The examples provided will describe the invention using a polystyrene substrate with an excimer laser system to form wells in a porous substrate. However, it is understood that the invention is broadly applicable to open pore materials in general and any means of removing substrate material to form wells therein.

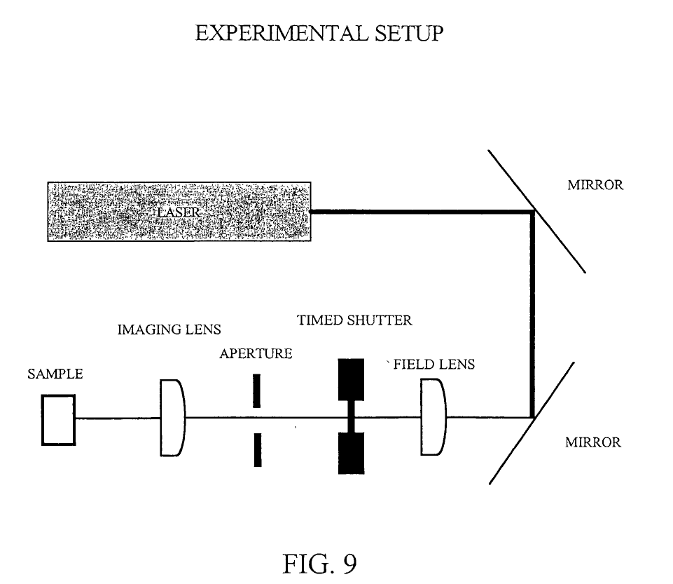

A laser system schematic is shown in FIG. 9. A laser, such as an excimer laser (model LPX210icc manufactured by the Lambda Physik Corporation, Goettingen, Germany) was used. This laser is a pulsed laser with a non-uniform beam and a pulse length of 34 ns. The gas medium used was KrF, which emits photons at the 248 nm wavelength. The experimental setup shown in FIG. 9 consisted of 2 mirrors, a field lens, and an imaging lens. The mirrors used were two dielectric mirrors coated to reflect in the UV. A field lens of focal length 2 meters, located before the aperture, reduced beam divergence. After the placement of the field lens, a time controlled electronic shutter regulated the number of pulses at high repetition rates. An aperture 6 mm in diameter was imaged by a 100 mm focal length lens on the sample. The aperture was positioned in the beam so as to create relatively uniformly illuminated spots on the sample. The average spot size was 4 mm in diameter, with an area of 12.6 mm². A Gentec model ED-500 joulemeter was used at the sample position to measure fluence. In other experiments a CO₂ TEA laser at a wavelength of 10.6 μm and pulse length of several hundred ns was used to drill through the fused polymer surface, illustrating that a wide range of lasers can be used.

A number of well holes were drilled at repetition rates of 1, 10, 50, and 100 Hz, with various numbers of laser pulse (shots) at each rate. The resulting well holes were circular in shape, with straight edges and a bottom surface that was uneven. Some of the holes displayed a web of polystyrene across the holes at some points between the opening and the bottom. After fabrication, the depth of each hole was measured and recorded. To measure the depth of each hole the sample was placed under a microscope, which was then focused on the edge of the hole at the surface layer. Using the fine focus knob, which was calibrated in microns, the microscope was focused on the bottom of the hole. From the rotation of the knob the hole depths could be calculated. A dye solution composed of food coloring, water, and dish soap was placed on the surface of the holes using a syringe after the completion of depth measurements. The degree of the liquid absorption of the dye revealed whether or not the sample well holes had penetrated the fused-cell surface layer and exposed the open celled core.

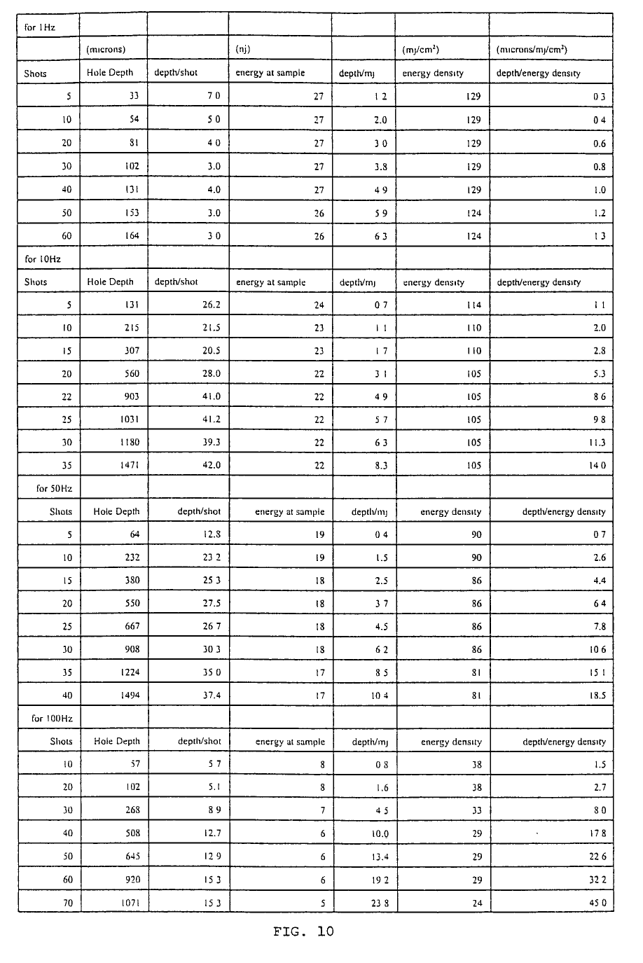

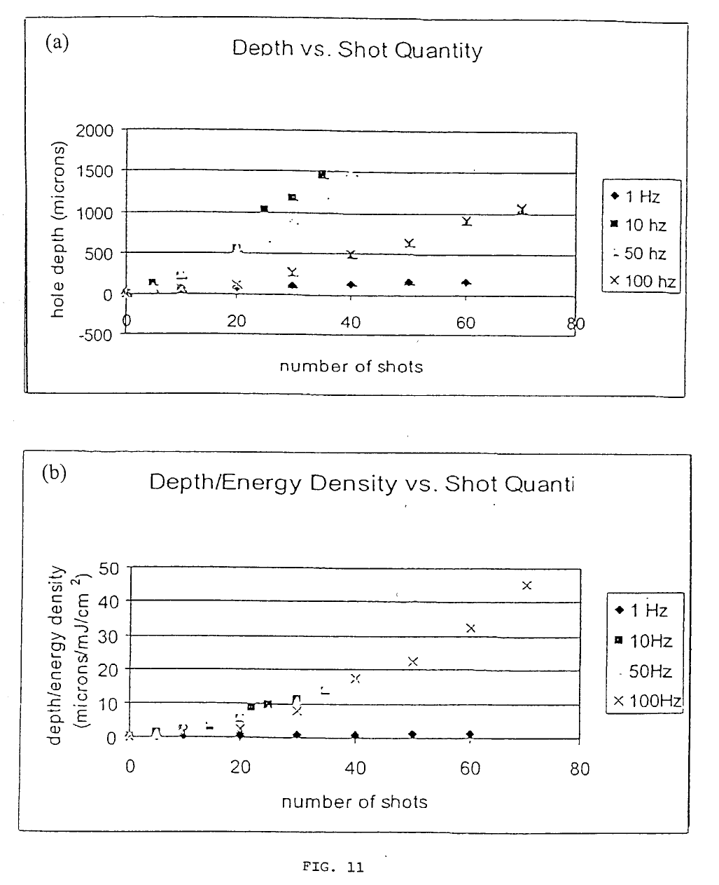

The results of the well hole depth measurements is shown in tabular form in FIG. 10. Error bars of about 15% are expected in the hole depth measurements due to the uneven base of the holes [FIG. 11(a)]. At 1 Hz the laser did not remove a significant amount of material at these laser fluences. Upon examination under the microscope, the 1 Hz holes showed minimal surface penetration. In testing the holes for absorption capabilities, no solution was absorbed. At 10, 50, and 100 Hz significant hole depth was achieved. However, upon dye-testing the holes for absorption, only some of the 10 and 50 Hz holes absorbed the food coloring solution. No solution was absorbed by the 100 Hz holes. The experimental fluence measurements ranged from 24-129 mJ/cm².

For most pulsed lasers, energy per pulse decreases at higher repetition rates, as shown by the broad range of fluence values above. Because of this effect, each repetition rate used in this series of experiments has a different value for the energy output of the laser. To be able to compare the values, the depth per energy density at the sample, known as the energy efficiency of removal, was compared to the number of pulses [FIG. 11(b)]. At 1 Hz, the figure indicates that the rate of removal was not significant for the energy density used. The figure shows a profound increase in energy efficiency of removal between 1 and 10 Hz. At greater than 10 Hz, however, the material removal rates are approximately the same.

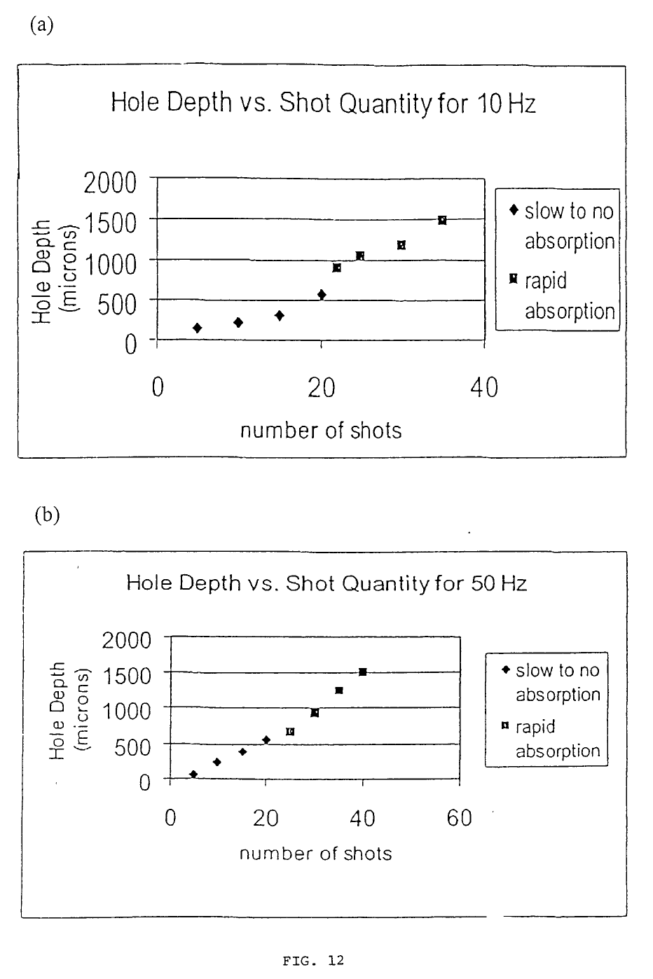

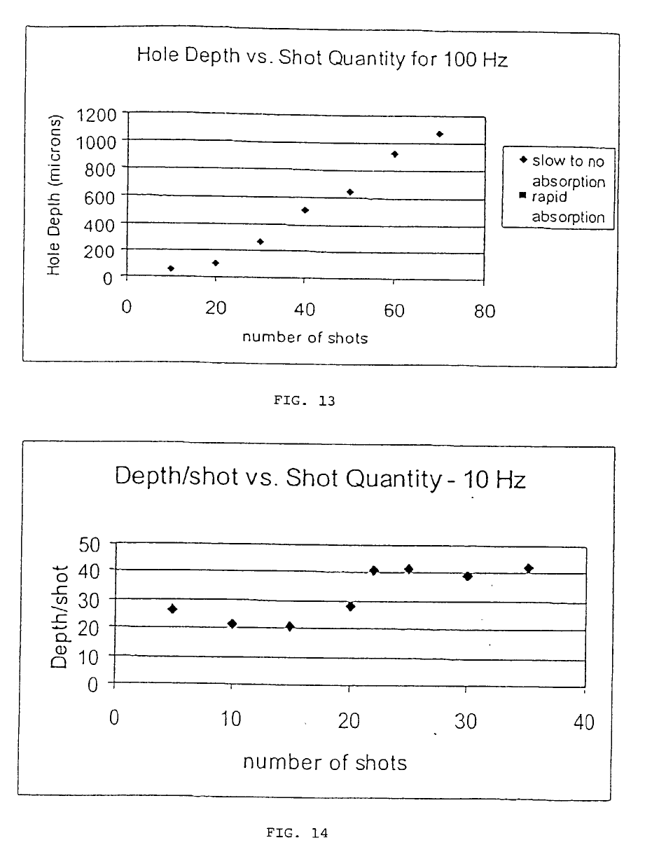

For constant repetition rates, the energy per pulse stayed fairly constant throughout the experiment. Thus, holes of different pulse quantities but at the same repetition rate may be compared in terms of depth as a function of shot quantity [FIGS. 12(a) and 12(b)]. In FIGS. 12(a) 10 Hz, 12(b) 50 Hz, and FIG. 13 100 Hz, the sample holes displaying significant dye absorption are indicated. On both graphs, the holes that show liquid absorption begin at a depth of approximately 600 μm. Therefore, in the well holes of at least 600 μm depth, the fused surface layer had been penetrated to the open-celled core below. The surface layer must therefore have a thickness of approximately 600 μm. Again, the sample holes drilled at 1 Hz had no significant depth and did not display any liquid absorption. The 100 Hz samples of surface-penetrating depth also displayed no liquid absorption.

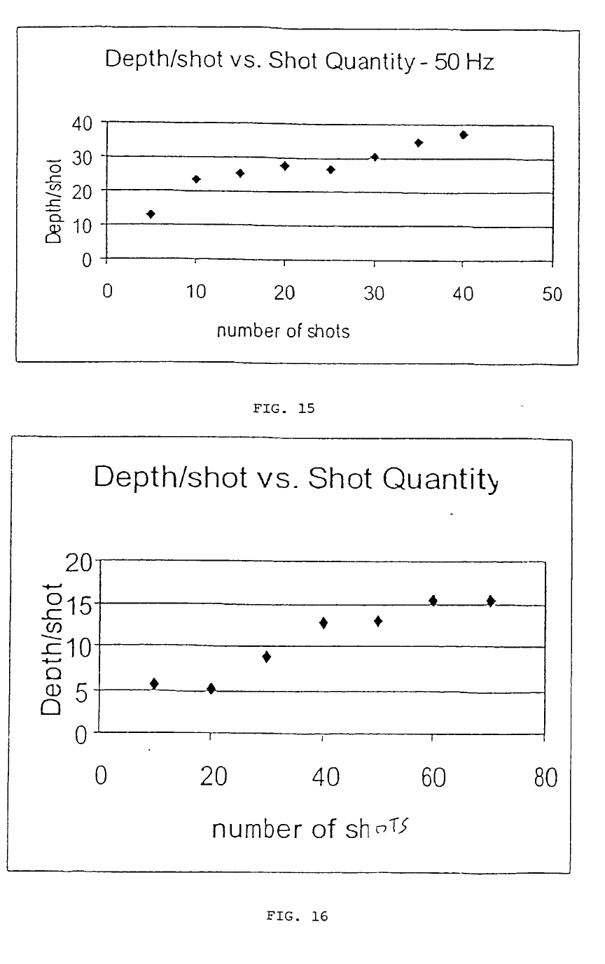

The sample was thought to have only two layers in terms of density; that of the fused-cell surface layer, and the open-celled core beneath. However, by examining the depth per shot as a function of pulse quantity, one can see the rates of removal for the individual repetition rates [FIGS. 14-16]. In each of these figures, three distinct rates are displayed. The rate, at the lower pulse quantities, stays fairly constant, and then displays a rapid increase, followed by another plateau of an approximately constant rate. This pattern indicates two possibilities: the existence of three distinct layers, with the first and third being the fused and open cell layers, respectively, and the middle layer consisting of a semi-fused transition layer, or the possibility of varied rates due to the uneven nature of the bottom of the hole, or more probably a combination of both effects.

From the liquid absorption testing, the polystyrene surface layer was found to require penetration of at least 600 μm to reach the open-celled core. Although the energy efficiency of removal remained approximately the same at repetition rates greater than or equal to 10 Hz, the effect on dye absorption capability varied greatly from 1 to 100 Hz. The results appear to be thermal in nature. The 1 Hz samples displayed no significant depth or liquid absorption. At 1 Hz, the material surface has time to cool before absorbing the next pulse from the laser. The increase in removal efficiency at greater than and equal to 10 Hz is undoubtedly due to a thermal buildup at the material surface. This same thermal effect contributes to the impermeability of the 100 Hz sample holes, which had penetrated the surface layer but displayed no dye absorption. A repetition rate of 100 Hz could cause an excessive buildup of heat at the surface of the sample, melting the open celled core and fusing the cells together. This, in effect, recreates the fused surface layer inside the hole and prevents any liquid absorption.

Another example of laser drilling of heterogenous material is given in K. Imen and S. D. Allen, Pulsed CO₂ laser drilling of green alumina ceramic, IEEE Transaction on Advanced Packaging, Part B, 22, 620 (1999). In this work, the laser energy was targeted to the polymer binder of the ceramic perform. By using a proper choice of laser conditions, clean removal resulted which did not fuse the surfaces. Using lasers which are strongly absorbed by water or other fluids in hydrogels or ceramic performs, similar clean removal resulting in fluidly connected access to the porous bulk could be obtained.

While the preferred embodiments of the invention have been illustrated and described, it will be clear that the invention is not so limited. Numerous modifications, changes, variations, substitutions and equivalents will occur to those skilled in the art without departing from the spirit and scope of the present invention.

The literature citations which are cited above are incorporated by reference herein for the reasons cited in the above text.

What is claimed is:

1. A method for forming microreactor devices, comprising the steps of:
providing a substrate having a porous bulk, and
removing discrete portions of said substrate to form at least one well in said substrate,
wherein said well provides access to said porous bulk.

2. The method of claim 1, wherein said substrate comprises at least one selected from the group consisting of polystyrene, polyethylene, polypropylene, polyurethane, metal foams, porous ceramics, aerogels and hydrogels.

3. The method of claim 1, wherein said substrate includes a non-porous surface layer.

4. The method of claim 3, wherein said removing step removes said non-porous surface layer but allows bulk portions of said substrate exposed by said removing step to remain substantially porous.

5. The method of claim 1, further comprising the step of placing a surface modification agent into at least one of said wells.

6. The method of claim 5, wherein said surface modification agent comprises sodium laureth sulfate (SLES) or sodium dodecyl sulfate (SDS).

7. The method of claim 5, wherein said surface modification agent changes chemical binding characteristics of at least a portion of said porous bulk.

8. The method of claim 1, wherein said removing step comprises laser ablation.

9. The method of claim 8, further comprising the step of applying an index matching fluid to said substrate prior to said removing step, wherein at least a portion of said well is a sub-surface channel or chamber.

10. The method of claim 1, wherein said removing step is performed under computer control.

11. A microreactor device, comprising:
a substrate having a porous bulk, and
at least one well or channel formed in said substrate.

12. The device of claim 11, wherein said device comprises a plurality of wells, wherein at least two of said plurality of wells having different structural properties.

13. The device of claim 11, wherein said substrate comprises at least one selected from the group consisting of polystyrene, polyethylene, polypropylene, polyurethane, metal foams, porous ceramics, aerogels and hydrogels.

14. The device of claim 11, wherein said substrate provides a non-porous surface layer.

15. The device of claim 11, wherein said at least one well include at least one hydrophilic region.

16. The device of claim 11, wherein at least a portion of said well is a sub-surface channel or chamber.

17. The device of claim 11, wherein said at least one well includes a surface modification agent which changes chemical binding characteristics of at least a portion of said porous bulk.

18. The device of claim 11, wherein at least a portion of one of said wells includes a non-porous portion.

19. The device of claim 11, further comprising at least a pair of electrically conductive electrodes disposed in said well or said channel.

20. The device of claim 19, wherein an electrical field generated through application of a potential difference across said pair of electrodes propels a fluid through said substrate.

21. A whole cell sensing device, comprising:
a substrate having a porous bulk;
at least one well formed in said substrate, and
at least one whole cell disposed in said well.

22. The whole cell sensor of claim 21, further comprising a non-porous and substantially rigid support, wherein said substrate is disposed on said rigid support.

23. The whole cell sensor of claim 22, further comprising an optically transparent cover plate disposed on said substrate.

24. A method for transporting fluids, comprising the steps of:
providing a substrate having a porous bulk, and
flowing at least one fluid through at least a portion of said substrate.

25. The method of claim 24, wherein at least one well or channel is formed in said substrate.

26. The method of claim 24, where said flowing step is under influence of an electrical field.

27. An artificial organ or functional tissue, comprising:
a substrate having a porous bulk and at least one functionalized surface formed from said porous bulk,
cellular material disposed in or on said functionalized surface, and
structure for supplying nutrients to and removing metabolic products from said cellular material.
